(19) United States
(12) Patent Application Publication
(10) Pub. No.: US 2009/0040993 A1
(43) Pub. Date: Feb. 12, 2009

(54) Apparatus and method for supporting mixed quality of service setup type in a broadband wireless communication system

(75) Inventors: Ki-Back Kim, Seongnam-si (KR); Jung-Shin Park, Seoul (KR); Han-Kyung Lee, Yongin-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/221,538

(22) Filed: Aug. 4, 2008

(30) Foreign Application Priority Data
Aug. 6, 2007 (KR) 2007-0078360
Mar. 26, 2008 (KR) 2008-0027776

(51) Int. Cl. H04Q 7/00

(52) U.S. Cl. 370/338

(57) ABSTRACT

A broadband wireless communication system is provided. The system includes: an access service network (ASN), consisting of at least one base station (BS) and at least one access service network_gateway (ASN-GW), for supporting a first quality of service (QoS) setup type for a first Mobile Station (MS) and for supporting a second QoS setup type for a second MS; the first MS for obtaining information on the first QoS setup type, which is an available QoS setup type of the first MS, through the access service network after an authentication process is completed during an initial network entry process, and for performing communication by processing a service flow (SF) according to the first QoS setup type; and the second MS for obtaining information on the second QoS setup type, which is an available QoS setup type of the second MS, through the access service network after the authentication process is completed during the initial network entry process, and for performing communication by processing the SF according to the second QoS setup type.

### CROSS-REFERENCE TO RELATED APPLICATION(S) AND CLAIM OF PRIORITY

This application claims priority under 35 U.S.C. §119(a) to a Korean patent application filed in the Korean Intellectual Property Office on Aug. 6, 2007 and assigned Serial No. 2007-78360 and a Korean patent application filed in the Korean Intellectual Property Office on Mar. 26, 2008 and assigned Serial No. 2008-27776, the entire disclosure of which is herein incorporated by reference.

### TECHNICAL FIELD OF THE INVENTION

The present invention relates to a broadband wireless communication system, and in particular, to an apparatus and method for ensuring an end-to-end quality of service (QoS) in a broadband wireless communication system.

### BACKGROUND OF THE INVENTION

Communication systems have conventionally been developed by considering only a system capability such as a wireless capacity, a service speed, and so forth. However, with the increase in types of services and the diversification in service level requirements of a user, communication systems have been currently operated by considering not only the system capability but also a quality of service (QoS) representing user satisfaction. Moreover, since available resources vary in a wireless communication system due to a time-variable environment and the mobility of a mobile station (MS), a policy considering various conditions is required for ensuring the QoS. In addition, as users of a broadband wireless communication system request a variety of high-speed services, establishment of a QoS policy is now regarded as a main issue for effective control of radio resource variation and traffic generation.

To provide a user with a satisfactory service, an end-to-end QoS has to be ensured. The end-to-end QoS is an application-layer QoS between a service provider and an MS or between two MSs and also is a QoS noticed by the user. To guarantee the end-to-end QoS, an interoperation process is necessary to ensure an overall QoS between an Internet protocol (IP) layer and a media access control (MAC) layer which are lower layers of the application layer. In this case, based on how the QoS policy is determined, different QoS interoperation processes are produced. That is, various QoS interoperation processes may exist according to a service provider (or operator).

The service provider (or operator) may establish the various QoS interoperation processes based on a plurality of QoS policies and may intend to support all of the plurality of QoS policies within one wireless access network. Moreover, the service provider (or operator) may intend to support a plurality of QoS interoperation processes simultaneously with respect to one MS. In this case, the system has to identify the QoS interoperation processes applied to the MS. This is because a service flow (SF) process applied to the MS may differ according to the QoS interoperation processes. Accordingly, in order to support the plurality of QoS interoperation processes in the wireless communication system, there is a need for a method for identifying the QoS interoperation processes applied to the MS.

### SUMMARY OF THE INVENTION

To address the above-discussed deficiencies of the prior art, it is a primary object of the present invention to solve at least the above-mentioned problems and/or disadvantages and to provide at least the advantages described below. Accordingly, an aspect of the present invention is to provide an apparatus and method for supporting a plurality of quality of service (QoS) setup types in a broadband wireless communication system.

Another aspect of the present invention is to provide an apparatus and method for identifying a QoS setup type applied to a mobile station (MS) in a broadband wireless communication system.

Another aspect of the present invention is to provide an apparatus and method for identifying a QoS setup type for each service flow (SF) in a broadband wireless communication system.

In accordance with an aspect of the present invention, a broadband wireless communication system is provided. The system includes: an access service network (ASN), consisting of at least one base station (BS) and at least one access service network_gateway (ASN-GW), for supporting a first QoS setup type for a first MS and for supporting a second QoS setup type for a second MS; the first MS for obtaining information on the first QoS setup type, which is an available QoS setup type of the first MS, through the access service network after an authentication process is completed during an initial network entry process, and for performing communication by processing an SF according to the first QoS setup type; and the second MS for obtaining information on the second QoS setup type, which is an available QoS setup type of the second MS, through the access service network after the authentication process is completed during the initial network entry process, and for performing communication by processing the SF according to the second QoS setup type.

In accordance with another aspect of the present invention, an MS apparatus in a broadband wireless communication system is provided. The apparatus includes: a receiver for receiving information on an available QoS setup type including at least one of a dynamic type, a semi-dynamic type, and a static type when an initial network entry process is performed; and a controller for providing communication control by processing an SF according to the available QoS setup type.

In accordance with another aspect of the present invention, a BS apparatus in a broadband wireless communication system is provided. The apparatus includes: a transmitter for transmitting, to an MS, information on an available QoS setup type including at least one of a dynamic type, a semi-dynamic type, and a static type when the MS performs an initial network entry process; and a controller for providing communication control by processing an SF according to the available QoS setup type.

In accordance with another aspect of the present invention, an access service network gateway apparatus in a broadband wireless communication system is provided. The apparatus includes: a manager for evaluating information on an available QoS setup type of an MS initially entering a network; and a communication unit for providing the QoS setup type information to a BS, wherein the QoS setup type is one of a dynamic type, a semi-dynamic type, and a static type.

In accordance with another aspect of the present invention, a policy decision function (PDF) apparatus in a broadband wireless communication system is provided. The apparatus includes: an evaluator for evaluating a QoS setup type of an MS when the MS requests a service through an application-layer message; and a communication unit for transmitting a signal for triggering either an SF-addition process or an SF-change process according to the QoS setup type, wherein the available QoS setup type is one of a dynamic type, a semi-dynamic type, and a static type.

In accordance with another aspect of the present invention, a method of operating an MS in a broadband wireless communication system is provided. The method includes: receiving information on an available QoS setup type including at least one of a dynamic type, a semi-dynamic type, and a static type when an initial network entry process is performed; and providing communication control by processing an SF according to the available QoS setup type.

In accordance with another aspect of the present invention, a method of operating a BS in a broadband wireless communication system is provided. The method includes: transmitting, to an MS, information on an available QoS setup type including at least one of a dynamic type, a semi-dynamic type, and a static type when the MS performs an initial network entry process; and providing communication control by processing an SF according to the available QoS setup type.

In accordance with another aspect of the present invention, a method of operating an access service network gateway in a broadband wireless communication system is provided. The method includes: evaluating information on an available QoS setup type of an MS initially entering a network; and providing the QoS setup type information to a BS, wherein the QoS setup type is one of a dynamic type, a semi-dynamic type, and a static type.

In accordance with another aspect of the present invention, a method of operating a PDF apparatus in a broadband wireless communication system is provided. The method includes: evaluating a QoS setup type of an MS when the MS requests a service through an application-layer message; and transmitting a signal for triggering either an SF-addition process or an SF-change process according to the QoS setup type, wherein the available QoS setup type is one of a dynamic type, a semi-dynamic type, and a static type.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a schematic view illustrating a structure of a broadband wireless communication system according to the present invention;

FIG. 2 is a block diagram of a mobile station (MS) in a broadband wireless communication system according to the present invention;

FIG. 3 is a block diagram of a base station (BS) in a broadband wireless communication system according to the present invention;

FIG. 4 is a block diagram of an access service network_gateway (ASN-GW) in a broadband wireless communication system according to the present invention;

FIG. 5 is a block diagram of a policy decision function (PDF) apparatus in a broadband wireless communication system according to the present invention;

FIG. 6 is a flowchart illustrating an operation of an MS in a broadband wireless communication system according to a first embodiment of the present invention;

FIG. 7 is a flowchart illustrating an operation of an MS in a broadband wireless communication system according to a second embodiment of the present invention;

FIG. 8 is a flowchart illustrating an operation of a BS in a broadband wireless communication system according to a first embodiment of the present invention;

FIG. 9 is a flowchart illustrating an operation of a BS in a broadband wireless communication system according to a second embodiment of the present invention;

FIG. 10 is a flowchart illustrating an operation of an access service network gateway in a broadband wireless communication system according to a first embodiment of the present invention;

FIG. 11 is a flowchart illustrating an operation of an access service network gateway in a broadband wireless communication system according to a second embodiment of the present invention; and

FIG. 12 is a flowchart illustrating an operation of a PDF in a broadband wireless communication system according to the present invention.

### DETAILED DESCRIPTION OF THE INVENTION

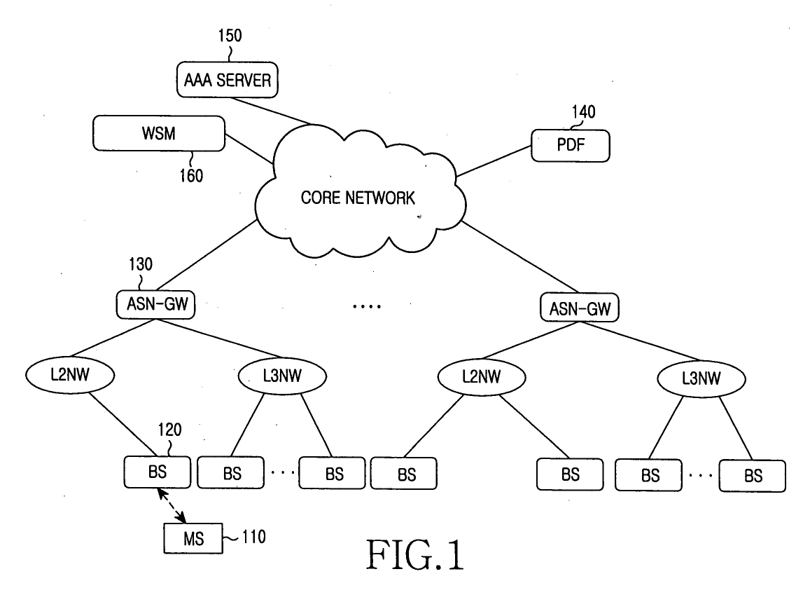

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

Preferred embodiments of the present invention will be described below with reference to the accompanying drawings. In the following description, well-known functions or constructions are not described in detail since they would obscure the invention in unnecessary detail.

The present invention to be described hereinafter relates to a technique for supporting a plurality of quality of service (QoS) interoperation processes in a broadband wireless communication system. Although an orthogonal frequency division multiplexing (OFDM)-based wireless communication system will be described as an example, the present invention may also apply to other types of wireless communication systems.

To facilitate explanations, it is assumed that several QoS interoperation processes are used in the present invention. The QoS interoperation processes are identified according to a service flow (SF) addition process and a QoS profile change process for the SF. It will be assumed hereinafter that the QoS interoperation processes are identified with a QoS setup type. The QoS setup type of the present invention is characterized as shown in Table 1 below.

TABLE 1

| QoS setup type | description |
|---|---|
| static | When an MS performs initial network entry, a |
| | predetermined number of SFs having a |
| | predetermined QoS profile are added. |
| | Transitions among an active mode, an admitted |
| | mode, and a provisioned mode can be made through |
| | an SF-change process. |
| | The QoS profile cannot be changed. |
| | The SF cannot be added after the initial network |
| | entry is completed. |
| semi-dynamic | When an MS performs initial network entry, a |
| | predetermined number of SFs having a |
| | predetermined QoS profile are added. |
| | Transitions among an active mode, an admitted |
| | mode, and a provisioned mode can be made through |
| | an SF-change process. |
| | The QoS profile can be changed through the |
| | SF-change process. |
| | The SF cannot be added after the initial network |
| | entry is completed. |
| dynamic | After initial network entry is completed, an SF |
| | is added when necessary. |
| | The SF can be changed and deleted. |
| | Mode management can be performed without a |
| | provisioned mode. |

That is, the wireless communication system of the present invention supports all of the plurality of QoS setup types shown in Table 1 above.

Referring to Table 1, a QoS profile cannot be changed when the QoS setup type is a static type. Therefore, irrespective of modes, the QoS profile of an SF generated according to the static type is always the same. In other words, although the QoS profile of the SF generated according to the static type may differ depending on each mode when management is performed differently for each of an active mode, an admitted mode, and a provisioned mode, once the QoS profile is determined, the same QoS profile is maintained for all modes.

In case of a semi-dynamic type, the QoS profile can be changed by an SF-change process. Therefore, the QoS profile of the SF generated according to the semi-dynamic type may differ depending on the modes. In this case, a QoS parameter set has a dependency relation in the order of the provisioned mode, the admitted mode, and the active mode. That is, the provisioned mode is a highest mode, and the active mode is a lowest mode. When in a lower mode, a QoS parameter value can be changed only within a range of a parameter value.

In case of a dynamic type, the SF can be changed and deleted. The QoS profile of the SF generated according to the dynamic type may differ depending on the modes. In this case, the QoS parameter set has a dependency relation in the order of the provisioned mode, the admitted mode, and the active mode. That is, the provisioned mode is a highest mode, and the active mode is a lowest mode. When in a lower mode, a QoS parameter value can be changed only within a range of a parameter value.

The wireless communication system of the present invention may allow only one QoS setup type for one mobile station (MS) or may allow distinctive QoS setup types for one MS according to SFs.

FIG. 1 is a schematic view illustrating a structure of a broadband wireless communication system according to the present invention.

Referring to FIG. 1, the broadband wireless communication system includes an MS 110, a base station (BS) 120, an access service network_gateway (ASN-GW) 130, a policy decision function (PDF) 140, an authentication authorization accounting (AAA) server 150, and a WiBro system manager (WSM) 160.

The MS 110 is a terminal equipment for user network access. The BS 120 is an equipment for managing wireless resources for network access of the MS 110 and may also be referred to as a radio access station (RAS). The ASN-GW 130 is an equipment for performing a gateway function of a subnet including a plurality of BSs and may also be referred to as an access control router (ACR). The ASN-GW 130 manages an SF, connection, and mobility of the MS 110. The SF is generated differently in an uplink scenario and a downlink scenario.

The PDF 140 determines a QoS parameter of the SF by applying a QoS policy of a system operator. Further, the PDF 140 can trigger an SF-addition process, an SF-change process, and an SF-deletion process. The PDF 140 is a functional element and may be implemented as an independent server or may be included in another network entity (NE) as a function. For example, an IP multimedia subsystem (IMS) server using a session initiate protocol (SIP) may include the PDF 140. The IMS server is for an IMS-based dynamic QoS based on the SIP and may not exist when a web-based dynamic QoS based on a hyper text transport protocol (HTTP) is used. A proxy-call state control function (P-CSCF) is a part of the IMS server. The P-CSCF and the PDF can be implemented with one server. The P-CSCF is a functional block of the IMS for receiving an SIP message transmitted by a user and may be referred to as an interface block.

The PDF 140 may have multiple functions, and some of the functions may be included in another NE. For example, the functions may be included in the AAA server 150, the WSM 160, or the ASN_GW 130. For another example, a policy, an accounting function, and an interface rule of a 3rd Generation Partnership Project (3GPP) or 3GPP2 system, such as a conventional policy charge rule function (PCRF), are maintained without alternation and a new intermediary PDF is provided to the PCRF and a wireless network (e.g., worldwide interoperability for microwave access (WiMAX), high-speed downlink packet access (HSDPA), or wireless local area network (WLAN)), so that an output of the PCRF is translated into a final output variable suitable for each wireless network. In this case, both of the PCRF and the intermediary PDF belong to the PDF 140.

Some of various parameters determined by the PDF 140 are commonly used in an application layer, an Internet protocol (IP) layer, a media access control (MAC) layer, and a physical layer. However, a parameter such as ‘grant interval’ is used only in the MAC layer. Examples of parameters used only in the MAC layer and the physical layer include ‘request/transmission policy’ (e.g., ‘whether to use fragmentation’, ‘whether to use packing’, ‘a compression scheme and whether to use compression’, ‘whether to use ARQ’, ‘whether to use HARQ’, and so forth).

The AAA server 150 manages authentication information and accounting information of MSs. User information is managed by a subscription profile repository (SPR). The SPR is a functional element and may belong to the AAA server or may exist as an independent server. The authentication information means information on service qualifications for all MSs to which services can be provided from a corresponding service provider. The authentication information can be represented with a user class. For example, the user class may be classified into premium, gold, silver, bronze, and so forth. The accounting information means information on charges which have to be paid by a user for the use of services of the MS.

The WSM 160 is an equipment for network management of a service provider and may also be referred to as an element management system (EMS). The WSM 160 delivers information on network configuration to equipments included in an access service network (ASN) and manages the equipments included in the ASN. The ASN is a group of one or more subnets managed by the same service provider. The ASN includes the BS 120 and the ASN-GW 130. Such a definition on the ASN will be used throughout the following descriptions.

In the schematic structure of the system shown in FIG. 1, the PDF 140 is configured to have multiple functions as follows. A PCRF, a first PDF, and a second PDF are used to replace the function of the PDF 140. The PCRF generates IP-layer QoS parameters by using application-layer QoS parameters which are service requirements of the application layer. The first PDF generates at least one IP-layer QoS parameter other than the IP-layer QoS parameters generated by the PCRF. The second PDF generates a QoS parameter set of a wireless access network by using the IP-layer QoS parameters generated by the PCRF and the at least one IP-layer QoS parameter generated by the first PDF. The second PDF may also be referred to as a policy charging enforcement function (PCEF).

When QoS parameters are generated in the wireless access network by using QoS parameters of the application layer, the generated QoS parameters can be delivered to an NE included in the wireless access network according to the following methods. In a first method, QoS parameters of a lower layer are configured in advance and are delivered during an initial network entry process when an SF is generated. In a second method, the QoS parameters of the lower layer are configured and delivered when a service is requested by the application layer after the initial network entry process is completed.

The second PDF may be included in an anchor ASN-GW. In addition, the second PDF may exist as a separate NE to manage one network access provider (NAP). When the second PDF exists as a separate NE, the second PDF can integrally regulate QoS policies of different network service providers (NSPs) by communicating with the first PDF included in the different NSPs.

The QoS parameters of the IP layer are output to the first PDF. However, if the NAP is one of the NSPs and can control the first PDF or the AAA server located in a core network, the first PDF or the AAA server can function as the second PDF, and the QoS policy and the accounting policy of the first PDF can be set to the same the QoS policy and the accounting policy of the AAA server. According to another embodiment, a system operation may perform an off-line action so that the first PDF of each NSP attains a mapping relation between the QoS parameters of the IP layer and the QoS parameters of the wireless access network. In this case, the first PDF can function as the second PDF. If the first PDF functions as the second PDF, the anchor ASN-GW including the second PDF does not function as the second PDF. Therefore, a control parameter is used to indicate whether the first PDF will function as the second PDF. According to the control parameter, the anchor ASN-GW including the second PDF determines whether to perform the function of the second PDF.

If a QoS SF is configured in the initial network entry process, a QoS profile of the QoS SF may be utilized when an application service is requested by the MS. For this, the PCRF has to know information on the QoS SF currently configured. The QoS profile is utilized by changing the QoS profile. Therefore, information on changes of the QoS profile is delivered from the PCRF to the ASN-GW through the first PDF, and the BS initiates a dynamic service change (DSC) process for applying the changes. Alternatively, the MS initiates the DSC process when the application layer of the MS triggers the MAC layer of the MS. However, when the DSC process is initiated by the MS, whether to permit the changes of the QoS profile has to be determined. Therefore, whether to permit the changes is determined by the ASN-GW according to a local policy or is determined by the PCRF upon receiving a report on the changes of the QoS profile from the ASN-GW.

If a QoS policy of the NSP or the NAP is changed and thus a QoS policy managed by the ASN-GW has to be changed for each SF, the following process is performed. An SF of an MS performing new initial network entry is generated according to a new policy. An SF of an MS performing network re-entry or handover is configured with new QoS parameters by performing the DSC process after a ranging process is completed. Alternatively, the SF of the MS performing network re-entry or handover is deleted, and a new SF is generated according to a new policy by performing a dynamic service addition (DSA) process. In addition, the system applies the new policy to an MS in an active mode through the DSC process while maintaining the active mode. Alternatively, the system provides the MS in the active mode with control information for reporting update of the QoS policy, allows the MS to transition to an idle mode so that the MS is ready to perform network re-entry, and applies the new QoS policy to the MS when network re-entry is performed.

In case of applying the new QoS policy using DSC process, the new QoS policy is applied as follows. When recognizing the change of the QoS Policy, a NE managing the QoS policy checks the change of QoS profiles according to the change of the QoS Policy, and orders the ASN-GW 130 to update the QoS profiles of SFs being used. Accordingly, the ASN-GW 130 changes the QoS profiles of SFs being used into new QoS profiles, and performs the DSC process to update QoS profiles. Herein, the DSC process is initiated by the ASN-GW 130 or the MS 110. In this case, the DSC process is allowable for all of QoS setup type, because the DSC process is performed due to the change of the QoS policy. In other words, the DSC process due to the change of the QoS policy is allowable for a static type, a semi-dynamic type, and a dynamic type.

A QoS interoperation management method proposed in the present invention will now be described with reference to FIG. 1.

The MS 110 and the ASN-GW 130, which controls network entry of the MS 110, have to know information on a QoS setup type available for the MS 110. This is because, when the MS 110 recognizes the available QoS setup type, a suitable operation can be performed and the ASN-GW 130 has to manage SFs of MSs.

According to an embodiment for attaining information on the available QoS setup type, after an authentication process is successfully completed in the initial network entry process of the MS 110, the ASN-GW 130 attains the available QoS setup type information of the MS 110 according to one of the following methods. In a first method, the AAA server 150 triggers an SPR, and attains the available QoS setup type information from the SPR. Thereafter, the AAA server 150 transmits an authentication confirm message or a registration process message by including the available QoS setup type information or transmits the available QoS setup type information through an independent message. In a second method, the AAA server 150 triggers the SPR to provide to the ASN-GW 130 with the available QoS setup type information. Alternatively, the SPR triggers the AAA server 150 to transmit the information to the ASN-GW 130. In a third method, when the ASN-GW 130 requests the AAA server 150 to send the available QoS setup type information, the AAA server 150 interoperates with the SPR and thus attains the available QoS setup type information. Thereafter, the AAA server 150 provides the information to the ASN-GW 130. Alternatively, the AAA server 150 triggers the SPR to provide the information to the ASN-GW 130. The available QoS setup type information may consist of an identifier for each QoS setup type. The ASN-GW 130 delivers to the MS 110 the available QoS setup type information upon receiving the information from the AAA server 150. Accordingly, the ASN-GW 130 and the MS 110 attain the available QoS setup type information of the MS 110.

Another embodiment for attaining available QoS setup type information of the MS 110 and the BS 120 will now be described. During the initial network entry process of the MS 110, the MS 110 reports its MS-type to the ASN-GW 130. The MS-type relates to a usage or the mobility of the MS 110. For example, the MS 110 may be a personal computer (PC) which is used in a fixed location or a cell phone which implies mobility. Upon evaluating the MS-type, the ASN-GW 130 determines an available QoS setup type of the MS 110 according to the QoS setup type information which is previously input with respect to the MS-type. That is, the QoS setup type depending on the MS-type is predetermined. For example, a static type or a semi-dynamic type is preferable for a PC-type MS whereas a dynamic type is preferable for a cell phone-type MS. Accordingly, the ASN-GW 130 and the MS 110 attain the available QoS setup type information of the MS 110. The QoS setup type information with respect to each MS-type may be delivered from the WSM 160 to the ASN-GW 130, or from the AAA server 150 to the ASN-GW 130.

If a user desires to use a service, the MS 110 transmits a service request message through the application layer. The PDF 140 evaluates the service request message transmitted through the application layer and thus recognizes the request of the MS 110. Then, according to the available QoS setup type of the MS 110, the PDF 140 determines which process will be triggered between an SF-addition process and an SF-change process. For example, if the QoS setup type of the MS 110 is the dynamic type, the PDF 140 triggers the SF-addition process for the MS 110 or the BS 120. If the QoS setup type of the MS 110 is the static type or the semi-dynamic type, the PDF 140 triggers the SF-change process for the MS 110 or the BS 120.

According to an embodiment, in order to evaluate the available QoS setup type information, the PDF 140 performs the following operations. The PDF 140 attains the available QoS setup type information of the MS 110 by interoperating with other equipments which know the available QoS setup type information of the MS 110. In this case, the PDF 140 uses an identifier of the MS 110, such as an NAI, an IP address, or a MAC address. For example, the SPR server or the AAA server 150 may manage the available QoS setup type information of the MS 110. According to another embodiment, the MS 110 differently configures session description (SD) information included in an application-layer message according to the QoS setup type. For example, the SD information includes items such as a port number, a classification (CS) rule, and so forth. The MS 110 may delete or add some of the items of the SD information to represent the QoS setup type. In this case, the PDF 140 can evaluate the available QoS setup type of the MS 110 through the SD information included in the application-layer message.

Occasionally, the MS 110 may request an SF-process which is not permitted. For example, the SF-addition process may be requested by the MS when only the static type or the semi-dynamic type is permitted. In this case, it is difficult for the MS 110 to prohibit the transmission of the application-layer message. Therefore, equipment included in the core network (e.g., the AAA server 150 or the PDF 140) informs the ASN that the request cannot be permitted, and as a result, the requested SF-process is prohibited. Alternatively, after the message is exchanged in the application layer, if the MS 110 generates a MAC-layer request for the SF, the ASN recognizes this and thus prohibits the requested SF-process.

If the MS 110 requests the SF-addition process or the SF-change process, the ASN may inquire the PDF 140 about whether the requested process can be permitted. In this case, the PDF 140 determines whether the requested process can be permitted by interoperating with the AAA server 150 or without the aid of other elements, and then informs the determination result to the ASN-GW 130.

Further, in the absence of triggering from a superordinate layer, the ASN and the MS 110 can change an SF mode through the SF-change process according to traffic generation. For example, if downlink traffic is generated, it can be evaluated by the ASN, and thus the BS 120 requests changes of the SF. If uplink traffic is generated, it can be evaluated by the MS 110, and thus the MS 110 requests changes of the SF.

After the message exchange process of the application layer is completed, the MS 110 can initiate the SF-process by allowing the application layer to trigger the MAC layer intrinsically. In case of the semi-dynamic type, the SF-change process is performed for the transition of the SF mode or for the change of QoS parameters. Therefore, when the application-layer message is transmitted, the MS indicates a purpose of the SF-change process. For example, the purpose of the SF-change process may be indicated by using the SD information or a newly defined parameter.

Hereinafter, structures and operations of NEs for supporting the aforementioned mixed QoS setup types will be described in detail with reference to the accompanying drawings.

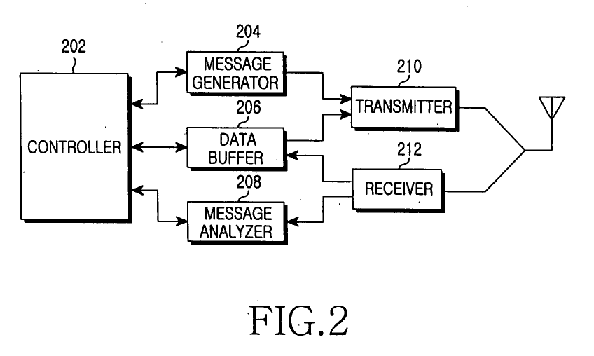

FIG. 2 is a block diagram of an MS in a broadband wireless communication system according to the present invention.

Referring to FIG. 2, the MS includes a controller 202, a message generator 204, a data buffer 206, a message analyzer 208, a transmitter 210, and a receiver 212.

The controller 202 controls SF-processing and data transmission/reception. In particular, according to the present invention, when power is on and thus an initial network entry process is performed, the controller 202 evaluates information on an available QoS setup type and provides control so that an SF is processed according to the available QoS setup type. The available QoS setup type information may consist of either one of the QoS setup types shown in Table 1 above or a combination of two or more QoS setup types.

The message generator 204 generates a control message to be transmitted. For example, the message generator 204 generates a control message of a MAC layer for the SF-processing and a control message of an application layer for the use of services. In particular, according to the present invention, the message generator 204 generates a control message including information indicating an MS-type to identify an available QoS setup type of a BS or an ASN-GW.

The data buffer 206 temporarily stores data to be transmitted to and received from the BS. For example, the data may be a voice packet for a Voice over Internet Protocol (VoIP) service, multimedia content, etc. The message analyzer 208 analyzes the received control message. In particular, according to the present invention, the message analyzer 208 analyzes the control message including the available QoS setup type information and then provides the available QoS setup type information to the controller 202.

The transmitter 210 converts an information bit-stream into radio frequency (RF) signals and transmits the RF signals to the BS through an antenna. Specifically, the transmitter 210 converts the information bit-stream into a coded-bit stream by coding the information bit-stream and converts the information bit-stream into complex symbols by modulating the coded bit-stream. Further, the transmitter 210 maps the complex symbols to subcarriers and thereafter generates OFDM symbols by performing an inverse fast Fourier transform (IFFT) operation. Then, the transmitter 210 up-converts the OFDM symbols into RF signals and then transmits the RF signals through the antenna.

The receiver 212 receives RF signals from the BS through the antenna and converts the RF signals into an information bit-stream. Specifically, the receiver 212 down-converts the RF signals received through the antenna and then splits the resultant RF signals into OFDM symbols. Then, the receiver 212 converts the OFDM symbols into complex symbols for each subcarrier by performing a fast Fourier transform (FFT) operation. Further, the receiver 212 converts the complex symbols into a coded bit-stream through demodulation and restores the information bit-stream by decoding the coded bit-stream.

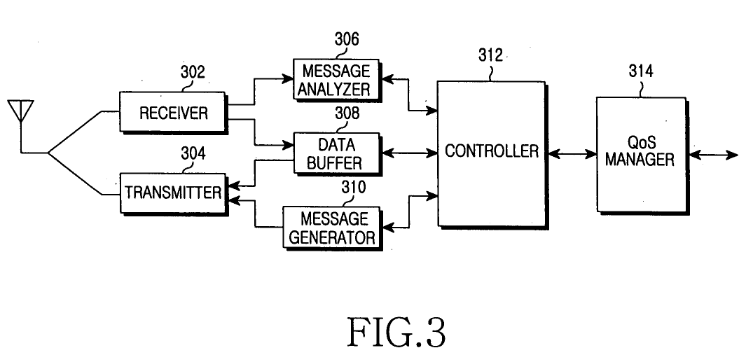

FIG. 3 is a block diagram of a BS in a broadband wireless communication system according to the present invention.

Referring to FIG. 3, the BS includes a receiver 302, a transmitter 304, a message analyzer 306, a data buffer 308, a message generator 310, a controller 312, and a QoS manager 314.

The receiver 302 receives RF signals from an MS through an antenna and converts the RF signals into an information bit-stream. Specifically, the receiver 302 down-converts the RF signals received through the antenna and thereafter splits the resultant RF signals into OFDM symbols. Then, the receiver 302 converts the OFDM symbols into complex symbols for each subcarrier by performing an FFT operation. Further, the receiver 302 converts the complex symbols into a coded bit-stream through demodulation and restores the information bit-stream by decoding the coded bit-stream.

The transmitter 304 converts an information bit-stream into RF signals and transmits the RF signals to the MS through the antenna. Specifically, the transmitter 304 converts the information bit-stream into a coded-bit stream by coding the information bit-stream and converts the information bit-stream into complex symbols by modulating the coded bit-stream. Further, the transmitter 304 maps the complex symbols to subcarriers and thereafter generates OFDM symbols by performing an IFFT operation. Then, the transmitter 304 up-converts the OFDM symbols into RF signals and then transmits the RF signals through an antenna.

The message analyzer 306 analyzes a control message received from the MS. In other words, the message analyzer 306 analyzes a control message of a MAC layer for wireless access of the MS. In particular, according to the present invention, the message analyzer 306 analyzes a control message including MS-type information received when the MS performs initial network entry and provides the MS-type information to the controller 312. The available QoS setup type information may consist of either one of the QoS setup types shown in Table 1 above or a combination of two or more QoS setup types.

The data buffer 308 temporarily stores data to be transmitted to and received from the MS. For example, the data may be a voice packet for a VoIP service, multimedia content, and so forth. The message generator 310 generates a control message to be transmitted to the MS. In particular, according to the present invention, the message generator 310 generates a control message including information on an available QoS setup type of the MS.

The controller 312 controls SF-processing and data transmission/reception. In particular, according to the present invention, the controller 312 provides control so that the available QoS setup type information is transmitted to an MS initially entering the network, and also provides control so that communication is made to the MS by processing an SF according to the available QoS setup type.

The QoS manager 314 evaluates the available QoS setup type information of the MS and provides the information to the controller 312. The QoS manager 314 for evaluating the available QoS setup type information may perform different functions according to embodiments. According to a first embodiment of the present invention, the QoS manager 314 attains the available QoS setup type information of the MS from any one of an AAA server, an SPR, and a PDF by interoperating with the AAA server. According to a second embodiment of the present invention, the QoS manager 314 has a table in which the available QoS setup type information is stored with respect to a predetermined MS-type, and evaluates the available QoS setup type information by using the table.

The function for evaluating the available QoS setup type information may be performed by an ASN-GW instead of the BS. In this case, the controller 312 of the BS requests the ASN-GW to send the available QoS setup type information of the MS, and upon receiving the information, transmits the available QoS setup type information to the MS. In addition, in this case, the QoS manager 314 may be omitted or may perform only a function for receiving the available QoS setup type information from the ASN-GW.

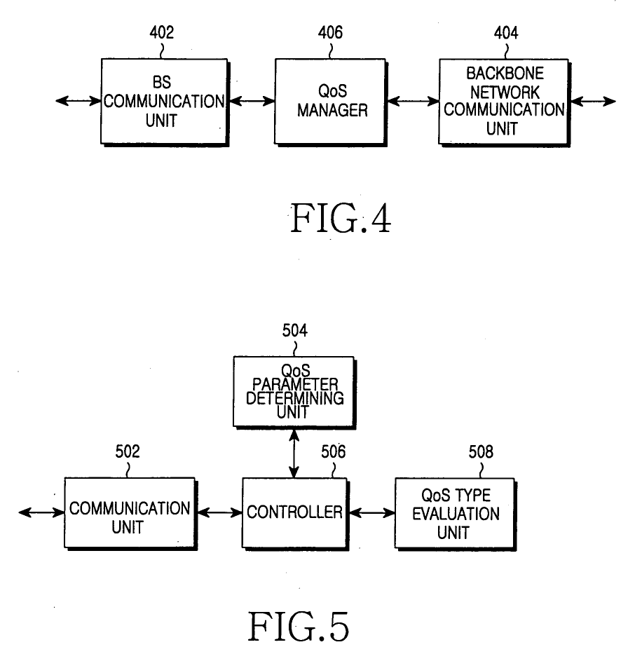

FIG. 4 is a block diagram of an ASN-GW in a broadband wireless communication system according to the present invention.

Referring to FIG. 4, the ASN-GW includes a BS communication unit 402, a backbone network communication unit 404, and a QoS manager 406.

The BS communication unit 402 transmits and receives a control message and data to and from an associated BS. For example, the BS communication unit 402 receives from the BS a control message for requesting available QoS setup type information of an MS, and transmits a control message including the available QoS setup type information. The backbone network communication unit 404 transmits and receives a control message and data to and from an NE of a backbone network. For example, the backbone network communication unit 404 receives from an AAA server the available QoS setup type information of the MS. The available QoS setup type information may consist of either one of the QoS setup types shown in Table 1 above or a combination of two or more QoS setup types.

The QoS manager 406 evaluates the available QoS setup type information of the MS initially entering the network and provides the information to the BS communication unit 402. The QoS manager 406 for evaluating the available QoS setup type information may perform different functions according to embodiments. According to a first embodiment of the present invention, the QoS manager 406 attains the available QoS setup type information of the MS from any one of an AAA server, an SPR, and a PDF by interoperating with the AAA server through the backbone network communication unit 404. According to a second embodiment of the present invention, the QoS manager 406 has a table in which the available QoS setup type information is stored with respect to a predetermined MS-type, and evaluates the available QoS setup type information by using the table.

FIG. 5 is a block diagram of a PDF apparatus in a broadband wireless communication system according to the present invention.

Referring to FIG. 5, the PDF apparatus includes a communication unit 502, a QoS parameter determining unit 504, a controller 506, and a QoS type evaluation unit 508.

The communication unit 502 transmits and receives information to and from another NE included in the system. The QoS parameter determining unit 504 determines QoS parameters of a newly added SF.

When the MS requests a service through an application layer, the controller 506 triggers a specific SF-process according to an available QoS setup type of the MS. For example, the controller 506 triggers an SF-addition process when the QoS setup type is a dynamic type whereas triggers an SF-change process for changing a QoS parameter of the SF when the available QoS setup type is a semi-dynamic type or a static type. That is, the controller 506 instructs the communication unit 502 to transmit a triggering signal. A target NE of the triggering signal may be the MS, a BS, or an ASN-GW. When an event occurs in which the MS requests an SF-process not coinciding with the available QoS setup type, the controller 506 reports the occurrence of the event to an ASN (i.e., the BS or the ASN-GW).

The QoS type evaluation unit 508 evaluates information on the available QoS setup type of the MS. The available QoS setup type information may consist of either one of the QoS setup types shown in Table 1 above or a combination of two or more QoS setup types. The QoS type evaluation unit 508 evaluates the available QoS setup type information by interoperating with another NE within the system. Alternatively, the QoS type evaluation unit 508 evaluates the available QoS setup type information by using SD information included in an application-layer control message received from the MS. For example, the QoS type evaluation unit 508 evaluates the available QoS setup type information by interoperating with an AAA server.

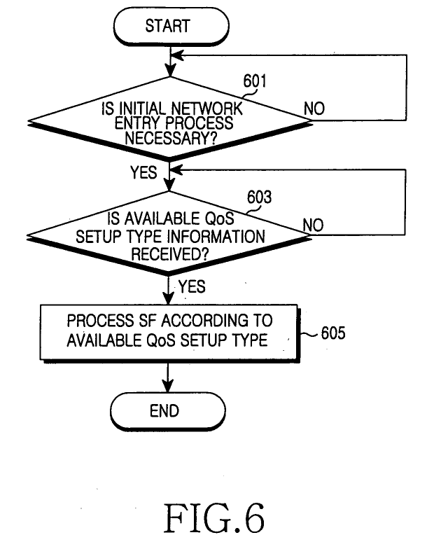

FIG. 6 is a flowchart illustrating an operation of an MS in a broadband wireless communication system according to a first embodiment of the present invention.

Referring to FIG. 6, the MS determines whether an initial network entry process is necessary in step 601. For example, the MS performs the initial network entry process when power is on.

If the initial network entry process is necessary, proceeding to step 603, the MS determines whether information on an available QoS setup type is received during the initial network entry process. For example, the available QoS setup type information is received after an authentication process is completed. The available QoS setup type information may consist of either one of the QoS setup types shown in Table 1 above or a combination of two or more QoS setup types.

Upon receiving the available QoS setup type information, proceeding to step 605, the MS completes the initial network entry process, and then performs communication by processing an SF according to the available QoS setup type.

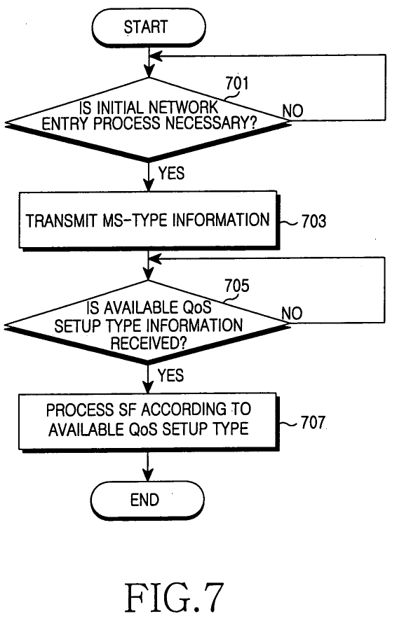

FIG. 7 is a flowchart illustrating an operation of an MS in a broadband wireless communication system according to a second embodiment of the present invention.

Referring to FIG. 7, the MS determines whether an initial network entry process is necessary in step 701. For example, the MS performs the initial network access process when power is on.

If the initial network entry process is necessary, proceeding to step 703, the MS transmits information indicating its MS-type during the initial network entry process. The MS-type relates to a usage or the mobility of the MS. For example, the MS may be a PC which is used in a fixed location or a cell phone which implies mobility.

In step 705, the MS determines whether information on an available QoS setup type is received. The available QoS setup type information may consist of either one of the QoS setup types shown in Table 1 above or a combination of two or more QoS setup types.

Upon receiving the available QoS setup type information, proceeding to step 707, the MS completes the initial network entry process, and then performs communication by processing an SF according to the available QoS setup type.

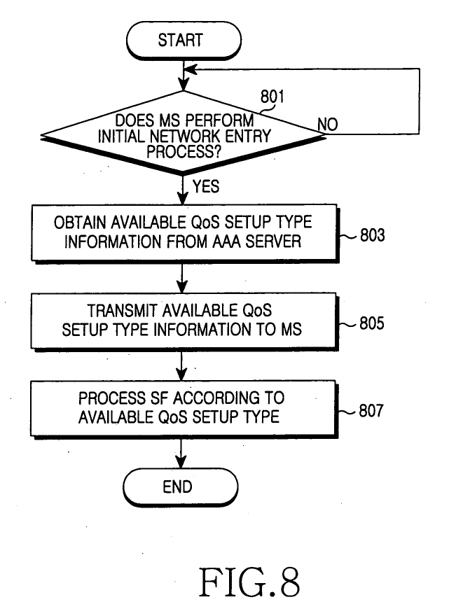

FIG. 8 is a flowchart illustrating an operation of a BS in a broadband wireless communication system according to a first embodiment of the present invention.

Referring to FIG. 8, the BS determines whether an MS performs an initial network entry process in step 801.

If the MS performs the initial network entry process, the BS interoperates with an AAA server and obtains information on an available QoS setup type of the MS in step 803. The available QoS setup type information may consist of either one of the QoS setup types shown in Table 1 above or a combination of two or more QoS setup types. The available QoS setup type information of the MS may be received from one of the AAA server, an SPR, or a PDF.

After obtaining the available QoS setup type information, the BS transmits the available QoS setup type information to the MS in step 805.

In step 807, the BS completes the initial network entry process, and performs communication by processing an SF according to the available QoS setup type.

In the description of FIG. 8, the BS interoperates with the AAA server and obtains the available QoS setup type information in step 803. However, the interoperation with the AAA server may be performed by an ASN-GW. In this case, the BS receives the available QoS setup type information only from the ASN-GW, and transmits the received information to the MS.

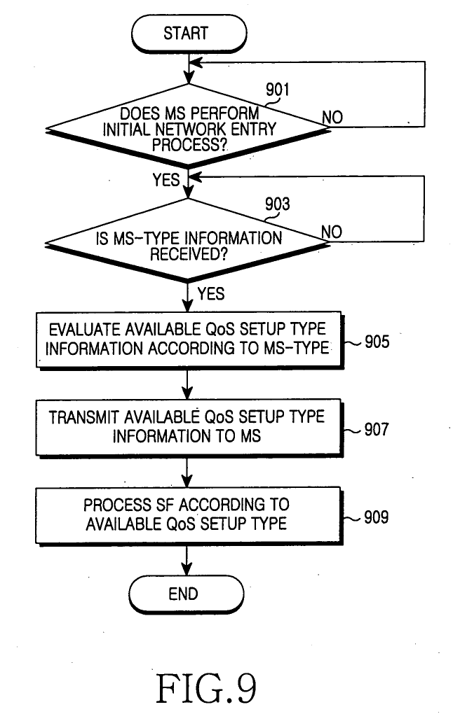

FIG. 9 is a flowchart illustrating an operation of a BS in a broadband wireless communication system according to a second embodiment of the present invention.

Referring to FIG. 9, the BS determines whether an MS performs an initial network entry process in step 901.

If the MS performs the initial network entry process, the BS determines whether information indicating an MS-type is received from the MS in step 903. The MS-type relates to a usage or the mobility of the MS. For example, the MS may be a PC which is used in a fixed location or a cell phone which implies mobility.

If the MS-type information is received, the BS evaluates information on an available QoS setup type depending on the MS-type in step 905. That is, the BS has a table in which the available QoS setup type information is stored with respect to a predetermined MS-type, and evaluates the available QoS setup type information by using the table. The available QoS setup type information may consist of either one of the QoS setup types shown in Table 1 above or a combination of two or more QoS setup types.

After obtaining the available QoS setup type information, the BS transmits the available QoS setup type information to the MS in step 907.

In step 909, the BS completes the initial network entry process, and performs communication by processing an SF according to the available QoS setup type.

In the description of FIG. 9, the BS uses a pre-stored table to evaluate the available QoS setup type information in step 905. However, the table may be managed by the ASN-GW. In this case, the BS receives the available QoS setup type information only from the ASN-GW, and transmits the received information to the MS.

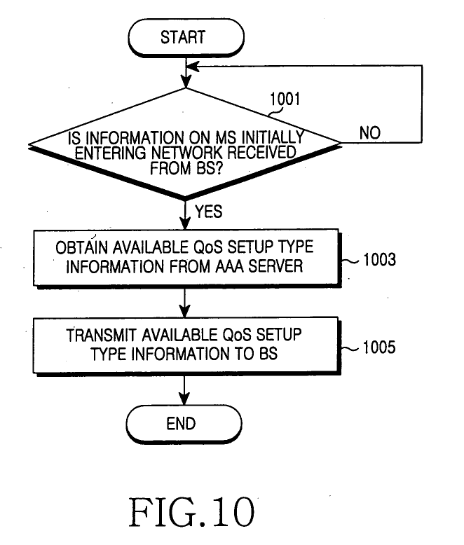

FIG. 10 is a flowchart illustrating an operation of an ASN-GW in a broadband wireless communication system according to a first embodiment of the present invention.

Referring to FIG. 10, the ASN-GW determines whether information of an MS initially entering the network is received from a BS in step 1001.

Upon receiving the information on the MS initially entering the network, the ASN-GW interoperates with an AAA server and thus obtains information on an available QoS setup type of the MS in step 1003. The available QoS setup type information may consist of either one of the QoS setup types shown in Table 1 above or a combination of two or more QoS setup types. The available QoS setup type information of the MS may be received from one of the AAA server, an SPR, or a PDF.

After obtaining the available QoS setup type information, the ASN-GW transmits the available QoS setup type information to the BS in step 1005.

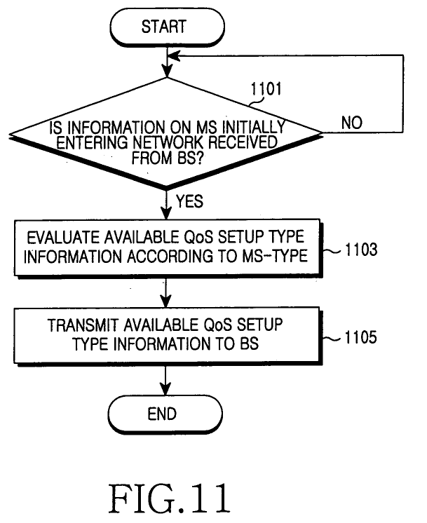

FIG. 11 is a flowchart illustrating an operation of an ASN-GW in a broadband wireless communication system according to a second embodiment of the present invention.

Referring to FIG. 11, the ASN-GW determines whether information of an MS initially entering the network is received from a BS in step 1101. In this case, the information of the MS includes information indicating an MS-type.

If the information of the MS initially entering the network is received, the ASN-GW evaluates information on an available QoS setup type depending on the MS-type in step 1103. That is, the ASN-GW has a table in which the available QoS setup type information is stored with respect to a predetermined MS-type, and evaluates the available QoS setup type information by using the table. The available QoS setup type information may consist of either one of the QoS setup types shown in Table 1 above or a combination of two or more QoS setup types.

After obtaining the available QoS setup type information, the ASN-GW transmits the available QoS setup type information to the BS in step 1105.

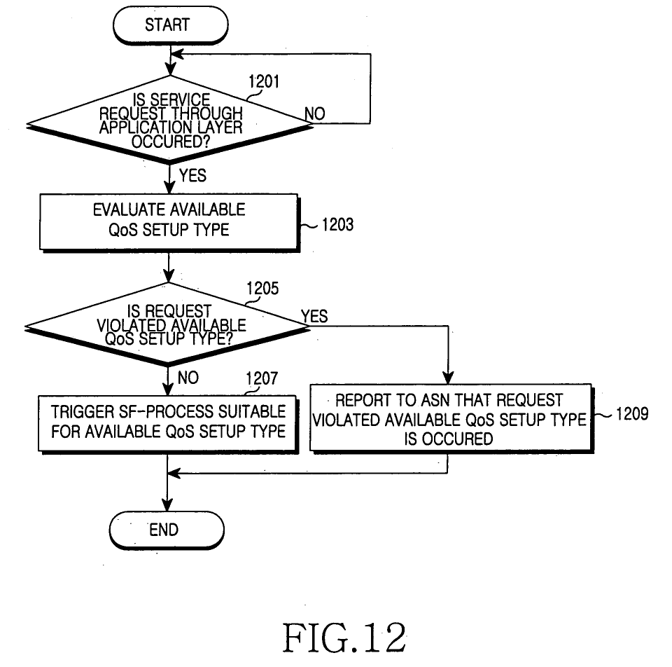

FIG. 12 is a flowchart illustrating an operation of a PDF in a broadband wireless communication system according to the present invention.

Referring to FIG. 12, the PDF determines whether a service request through an application layer has occurred in step 1201.

If the service is requested from the MS, the PDF evaluates an available QoS setup type of the MS in step 1203. In this case, the PDF evaluates the available QoS setup type by interoperating with another NE (e.g., an AAA server, an SPR, and so forth) within the system or by using SD information included in an application-layer message. The available QoS setup type may consist of either one of the QoS setup types shown in Table 1 above or a combination of two or more QoS setup types.

After evaluating the available QoS setup type, the PDF determines whether the request violates the available QoS setup type in step 1205.

If the request does not violate the available QoS setup type, the PDF triggers an SF-process suitable for the available QoS setup type in step 1207. For example, the PDF triggers an SF-addition process when the QoS setup type is a dynamic type whereas triggers an SF-change process for changing a QoS parameter of the SF when the available QoS setup type is a semi-dynamic type or a static type. A target NE of the triggering signal may be the MS, a BS, or an ASN-GW.

Otherwise, if the request violates the available QoS setup type, the PDF reports to the ASN (i.e., the BS and the ASN-GW) that a request violating the available QoS setup type has occurred in step 1209.

According to the present invention, a plurality of QoS setup types can be supported in a broadband wireless communication system by exchanging and managing available QoS setup type information.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A broadband wireless communication system comprising:
an access service network, consisting of at least one base station and at least one access service network_gateway, for supporting a first quality of service (QoS) setup type for a first mobile station (MS) and for supporting a second QoS setup type for a second mobile station;
the first mobile station for obtaining information on the first QoS setup type, which is an available QoS setup type of the first mobile station, through the access service network after an authentication process is completed during an initial network entry process, and for performing communication by processing a service flow (SF) according to the first QoS setup type; and
the second mobile station for obtaining information on the second QoS setup type, which is an available QoS setup type of the second mobile station, through the access service network after the authentication process is completed during the initial network entry process, and for performing communication by processing the service flow according to the second QoS setup type.

2. The system of claim 1, wherein each of the first QoS setup type and the second QoS setup type is one of a dynamic type, a semi-dynamic type, and a static type.

3. The system of claim 1, further comprising:
an authentication authorization accounting (AAA) server for managing authentication information of the mobile stations and for providing the QoS setup type information of the first mobile station to the access service network after the authentication process of the first mobile station is completed; and
a subscription profile repository for providing the QoS setup type information of the first mobile station to the authentication authorization accounting server at the request of the AAA server,
wherein the subscription profile repository is a part of functional elements of the AAA server or is an independent entity.

4. The system of claim 1, further comprising:
an AAA server for managing authentication information of the mobile stations and for triggering a subscription profile repository to provide the access service network with the QoS setup type information of the first mobile station; and
the subscription profile repository for providing the QoS setup type information of the first mobile station to the access service network at the triggering of the AAA server,
wherein the subscription profile repository is a part of functional elements of the AAA server or is an independent entity.

5. The system of claim 1, further comprising:
an AAA server for managing authentication information of the mobile stations and for triggering a subscription profile repository to provide the access service network with the QoS setup type information of the first mobile station;
the subscription profile repository for providing the QoS setup type information of the first mobile station to a policy decision function at the triggering of the AAA server; and
the policy decision function for providing the QoS setup type information of the first mobile station to the access service network,
wherein the subscription profile repository is a part of functional elements of the AAA server or is an independent entity.

6. The system of claim 1, further comprising:
a policy decision function for obtaining the QoS setup type information of the first mobile station from a subscription profile repository at the request of the access service network and for providing the QoS setup type information of the first mobile station to the access service network; and
the subscription profile repository for providing the QoS setup type information of the first mobile station to the policy decision function at the request of the policy decision function.

7. The system of claim 1, further comprising:
a policy decision function for triggering a subscription profile repository to provide the access service network with the QoS setup type information of the first mobile station; and
the subscription profile repository for providing the QoS setup type information of the first mobile station to the access service network at the triggering of the policy decision function.

8. The system of claim 1, wherein the first mobile station reports MS-type of the first mobile station to the access service network, and
wherein the access service network evaluates the available QoS setup type depending on the MS-type of the first mobile station and provides the available QoS setup type information to the first mobile station.

9. The system of claim 1, further comprising a policy decision function for evaluating a QoS setup type of a mobile station when the mobile station requests a service through an application-layer message and for triggering either an SF-addition process or an SF-change process according to the QoS setup type.

10. The system of claim 9, wherein the policy decision function evaluates the QoS setup type of the mobile station by using a separate device in the system.

11. The system of claim 10, wherein the separate device in the system is an AAA server or an IP multimedia subsystem (IMS) server.

12. The system of claim 9, wherein the policy decision function evaluates the QoS setup type of the mobile station by using session description (SD) information included in the application-layer message transmitted from the mobile station.

13. The system of claim 9, wherein the policy decision function triggers the SF-addition process at the request of a dynamic type mobile station, and triggers the SF-change process at the request of a semi-dynamic type or a static type mobile station.

14. The system of claim 9, wherein, when a service request of a mobile station through an application layer violates the available QoS setup type of the mobile station, the policy decision function reports to the access service network that a request violating the available QoS setup type has occurred, and
wherein the access service network prohibits the service flow process corresponding to the service request that violated the available QoS setup type.

15. The system of claim 1, further comprising a third mobile station for performing communication by processing the service flow according to a different QoS setup type for each service flow.

16. A mobile station (MS) apparatus in a broadband wireless communication system, the apparatus comprising:
a receiver for receiving information on an available quality of service (QoS) setup type including at least one of a dynamic type, a semi-dynamic type, and a static type when an initial network entry process is performed; and
a controller for providing communication control by processing a service flow (SF) according to the available QoS setup type.

17. The apparatus of claim 16, further comprising a transmitter for transmitting MS-type information to a base station.

18. A base station (BS) apparatus in a broadband wireless communication system, the apparatus comprising:
a transmitter for transmitting, to a mobile station (MS), information on an available quality of service (QoS) setup type including at least one of a dynamic type, a semi-dynamic type, and a static type when the mobile station performs an initial network entry process; and
a controller for providing communication control by processing a service flow (SF) according to the available QoS setup type.

19. The apparatus of claim 18, further comprising
a manager for obtaining the available QoS setup type information of the mobile station from one of an authentication authorization accounting (AAA) server, a subscription profile repository, and a policy decision function after an authentication process of the mobile station is completed,
wherein the transmitter transmits to the mobile station the available QoS setup type information.

20. The apparatus of claim 18, further comprising:
a receiver for receiving information indicating an MS-type from the mobile station; and
a manager for evaluating the available QoS setup type information depending on the MS-type by using a table in which the available QoS setup type information is stored with respect to the MS-type,
wherein the transmitter transmits to the mobile station the available QoS setup type information depending on the MS-type.

21. An access service network_gateway (ASN-GW) apparatus in a broadband wireless communication system, the apparatus comprising:
a manager for evaluating information on an available quality of service (QoS) setup type of a mobile station (MS) initially entering a network; and
a communication unit for providing the QoS setup type information to a base station,
wherein the QoS setup type is one of a dynamic type, a semi-dynamic type, and a static type.

22. The apparatus of claim 21, wherein the manager obtains the available QoS setup type information of the mobile station from one of an authentication authorization accounting (AAA) server, a subscription profile repository, and a policy decision function after an authentication process of the mobile station is completed.

23. The apparatus of claim 21, wherein the communication unit receives information indicating an MS-type of the mobile station from the base station, and
wherein the manager evaluates the available QoS setup type information depending on the MS-type.

24. A policy decision function apparatus in a broadband wireless communication system, the apparatus comprising:
an evaluator for evaluating a quality of service (QoS) setup type of a mobile station (MS) when the mobile station requests a service through an application-layer message; and
a communication unit for transmitting a signal for triggering either a service flow (SF)-addition process or an SF-change process according to the QoS setup type,
wherein the available QoS setup type is one of a dynamic type, a semi-dynamic type, and a static type.

25. The apparatus of claim 24, wherein the evaluator obtains information on the available QoS setup type from a separate device in the system or evaluates the QoS setup type information of the mobile station by using session description (SD) information included in the application-layer message.

26. The apparatus of claim 24, wherein, if the QoS setup type is the dynamic type, the communication unit transmits a signal for triggering the SF-addition process, and
wherein, if the QoS setup type is the semi-dynamic type or the static type, the communication unit transmits a signal for triggering the SF-change process.

27. The apparatus of claim 24, wherein, when a service request of a mobile station through an application layer violates the available QoS setup type of the mobile station, the communication unit transmits a message for reporting to the access service network that a request violating the available QoS setup type has occurred.

28. A method of operating a mobile station (MS) in a broadband wireless communication system, the method comprising:
receiving information on an available quality of service (QoS) setup type including at least one of a dynamic type, a semi-dynamic type, and a static type when an initial network entry process is performed; and
providing communication control by processing a service flow (SF) according to the available QoS setup type.

29. The method of claim 28, further comprising transmitting MS-type information to a base station.

30. A method of operating a base station in a broadband wireless communication system, the method comprising:
transmitting, to a mobile station (MS), information on an available quality of service (QoS) setup type including at least one of a dynamic type, a semi-dynamic type, and a static type when the mobile station performs an initial network entry process; and
providing communication control by processing a service flow (SF) according to the available QoS setup type.

31. The method of claim 30, further comprising:
obtaining the available QoS setup type information of the mobile station from one of an authentication authorization accounting (AAA) server, a subscription profile repository, and a policy decision function after an authentication process of the mobile station is completed; and
transmitting to the mobile station the available QoS setup type information.

32. The method of claim 30, further comprising:
receiving information indicating an MS-type from the mobile station;
evaluating the available QoS setup type information depending on the MS-type by using a table in which the available QoS setup type information is stored with respect to the MS-type; and
transmitting to the mobile station the available QoS setup type information depending on the MS-type.

33. A method of operating an access service network_gateway in a broadband wireless communication system, the method comprising:
evaluating information on an available quality of service (QoS) setup type of a mobile station (MS) initially entering a network; and
providing the QoS setup type information to a base station,
wherein the QoS setup type is one of a dynamic type, a semi-dynamic type, and a static type.

34. The method of claim 33, wherein the available QoS setup type information of the mobile station is obtained from one of an authentication, authorization, and accounting (AAA) server, a subscription profile repository, and a policy decision function after an authentication process of the mobile station is completed.

35. The method of claim 33, wherein the evaluating information on an available QoS setup type of a mobile station initially entering a network further comprises:
receiving information indicating an MS-type of the mobile station from the base station; and
evaluating the available QoS setup type information depending on the MS-type.

36. A method of operating a policy decision function apparatus in a broadband wireless communication system, the method comprising:
evaluating a quality of service (QoS) setup type of a mobile station (MS) when the mobile station requests a service through an application-layer message; and
transmitting a signal for triggering either a service flow (SF) -addition process or an SF-change process according to the QoS setup type,
wherein the available QoS setup type is one of a dynamic type, a semi-dynamic type, and a static type.

37. The method of claim 36, wherein information on the available QoS setup type is obtained from a separate device in the system or is evaluated by using session description (SD) information included in the application-layer message.

38. The method of claim 36, wherein transmitting a signal for triggering either an SF-addition process or an SF-change process comprises:
if the QoS setup type is the dynamic type, transmitting a signal for triggering the SF-addition process; and
if the QoS setup type is the semi-dynamic type or the static type, transmitting a signal for triggering the SF-change process.

39. The method of claim 36, further comprising, when a service request of a mobile station through an application layer is violated the available QoS setup type of the mobile station, transmitting a message for reporting to the access service network that request violated the available QoS setup type is occurred.
